(19) United States
(12) Patent Application Publication
(10) Pub. No.: US 2019/0357510 A1
(43) Pub. Date: Nov. 28, 2019

(54) Lubricant Applicator for Fishing Lines and Leaders

(71) Applicant: Juan Carlos Sampedro Martin, Arevalo (ES)

(72) Inventor: Juan Carlos Sampedro Martin, Arevalo (ES)

(21) Appl. No.: 16/419,104

(22) Filed: May 22, 2019

(30) Foreign Application Priority Data
May 24, 2018 (ES) U 201830760

(51) Int. Cl. A01K 87/04; F16N 7/02

(52) U.S. Cl. CPC A01K 87/04; A01K 91/12; F16N 7/02

(57) ABSTRACT

A new utensil which solves the aforementioned problems due to developing an instrument with a number of advantages compared with the traditional method already described for lubrication of fishing lines and leaders. This tool fundamentally helps this operation to be made comfortably, fast, in such a way the user can hold the rod while proceeding to the greasing and the guiding, for the storage of the assembly into the reel, is done through this, so the risk of the lubricant not remaining finally on the fishing line and/or leader is diminished. It is basically made up by two parts, on the one side, an outer cover which enables its fixing to the rod through the upper hole, also houses the support material for the lubricant and contains a cavity that allows the storage of other instruments, as well as the tool for the impregnation of the support material with the lubricant.

### CROSS REFERENCE TO RELATED APPLICATION

This application claims priority to and takes the benefit of Spanish Patent Application No. U 201830760 filed on May 24, 2018, the contents of which are herein incorporated by reference.

### BACKGROUND OF THE INVENTION

### Field of the Invention

The present invention pertains to the field of sports, specifically to that of fishing, and more particularly to the field of fishing known as “with tapered leaders”, “whip fishing” or “fly fishing”.

The object of the present invention is a new lubricant applicator for lines and the different sections the fishing leader is made up by, which allows the application of such substance being this utensil preferably attached to the rod, allowing the user to have their hands free to proceed according to their abilities to a comfortable, easy, clean lubrication and winding and with guarantees.

### Description of the Related Art

At present there are multiple lubricants in the market for fishing lines and leaders, which provide properties that allow to reduce friction of these elements with the guides of the rod and/or to increase their buoyancy. The format in which they are sold can incorporate a fragment of porous material, either a cloth, foam or similar material in order to distribute on it the flotation lubricant and proceed to its application on the line and/or braided, monofilament conic and/or knotted conic leaders. This form of operation has a number of drawbacks which make this an operation that presents some discomfort, being necessary to use both hands to grease, which makes difficult holding simultaneously the rod by the same person. Also, the hands are impregnated with lubricant which ends up in other places such as clothes and/or the rod which can diminish its grip, besides that, once greased the different elements, they are collected to be stored into the reel which implies a risk of removing the lubricant, as it is necessary to guide them for a uniform distribution inside it.

At present there is no knowledge of the existence of an instrument specifically designed to ease this operation, enabling a uniform, fast, clean, comfortable greasing and with guarantees that the different elements, once collected into the reel, are perfectly lubricated.

### SUMMARY OF THE INVENTION

The inventor of the present application has developed a new utensil which solves the aforementioned problems due to developing an instrument with a number of advantages compared with the traditional method already described for lubrication of fishing lines and leaders. This tool fundamentally helps this operation to be made comfortably, fast, in such a way the user can hold the rod while proceeding to the greasing and the guiding, for the storage of the assembly into the reel, is done through this, so the risk of the lubricant not remaining finally on the fishing line and/or leader is diminished. It is basically made up by two parts, on the one side, an outer cover which enables its fixing to the rod through the upper hole, also houses the support material for the lubricant and contains a cavity that allows the storage of other instruments, as well as the tool for the impregnation of the support material with the lubricant. It is on the outer cover where the user grips to perform the different actions. On the other side, in the inside of the outer cover, the support material is located, which is impregnated with the lubricant to grease the fishing line and/or leaders afterwards.

According to the foregoing, the present invention is addressed to a novel lubricant applicator for fishing lines and leaders. Each of these parts are defined in greater detail below:

a) The outer cover, preferably formed by two assembled parts, preferably has two essentially circular holes, of equal or different section and whose axis may be parallel or not, spaced by a distance preferably less than 20 centimeters. The main function of the upper hole is to enable its attachment to the rod, allowing both to rotate it and to move it along it. Its geometry is conceived for making the fixing on the closest section to that of the rod's handle, being possible to move it along it, although the user has the option to place it in other section enabling its handling. This way, each user can adjust it according to their criteria, to a convenient distance for its use. The possibility of rotation provided, having the rod itself as an axis, makes the guiding operation to collect into the reel the assembly formed by the line and leader, enable an adequate distribution of these elements inside it. This upper hole preferably has a protection of a foamy material, whose main function is not to damage the rod. Its longitudinal section will be preferably variable so that it can be adjusted to that of the sections of a standard rod. In the case of the lower hole, it fundamentally has the object of housing the support material of the lubricant and it will be through this that the line and/or different sections of the leader will be passed for their greasing.

The term “essentially circular” refers herein to a fundamentally circular shape, but that it could be ellipsoidal provided that it does not significantly differs from the said circular shape.

This outer cover preferably has its front face inclined in order to help the user see how the elements to be lubricated come into the utensil, while the rear face is preferably perpendicular to the axis of rotation or hinge and to the lower edge, the point of union of the right and left outer covers. Preferably, the angle formed by the vertical with the front faces of the outer cover is between 5° and 20°, and more preferably between 10° and 15°. To put the said elements in contact with the lubricant, the parts of the cover are separated, either by a hinge or similar as an axis of rotation, or by separating them completely losing contact between them, in any case being the support material accessible. It will be in this where the elements to be lubricated will be placed for them to get in contact with the lubricant, applied prior to this operation on the support material. Once introduced, the outer cover is assembled leaving the utensil ready to proceed to the greasing. It is during the operation of storing the line and/or leader into the reel when lubrication of these elements takes place.

The parts making part of the outer cover are preferably symmetrical and have a set of ridges and valleys which provide greater roughness favoring grip by the user.

b) The support material of the lubricant will be preferably grooved, thus favoring the placing of a certain quantity of lubricant to be distributed, preferably having a drill hole preferably a through hole, whose diameter varies from 0.5 mm to 5 mm. Preferably, this will be of a foamy material whose elasticity is high, thus favoring a greater contact surface with the line and/or the sections making up the fishing leader, taking advantage of its capacity to recover its original shape once the lubrication process is finished.

The support material is preferably divided into two parts by an inclined plane with respect to the vertical plane.

c) The tool for the impregnation of the support material with the lubricant which will preferably be of plastic material and with two differentiated parts; one for holding so that the user can safely handle it and other to grab the desired quantity of lubricant and spread it on the support material in such a way that it allows the user not to get in contact with the lubricant.

At present, lubricants are accompanied by a fragment of support material for the user to impregnate it and proceed to greasing. Generally, they are pieces of synthetic tissues which can be folded without difficulty to house the fishing line and/or leader in order to put them in contact with the lubricant and proceed to the action itself. With this novel system the user will not have to hold such fragment of material to carry out lubrication thereby the operation itself will be more comfortable, fast, clean and with guarantees that grease does not remain anywhere else but on the elements to be lubricated.

The inventor of the present application has verified in different tests that the support material to be placed in this utensil must be that which may be preferably manufactured in a volume instead of plates or sheets in which two of its dimensions predominate over a third one. Thus, the material can be given the necessary shape for its assembly with the outer cover securing it preferably by means of an adhesive between their contact surfaces. In any case, its shape is also likely to be achieved by coupling successive plates or sheets of any material with this property.

### BRIEF DESCRIPTION OF THE DRAWINGS

To complement the description which is being made and in order to help a better understanding of the characteristics of the invention, as an integrating part of said description, this is accompanied by a set of drawings wherein with an illustrative and not limiting nature, the following has been represented:

FIG. 1a—shows a side view of the device according to the present invention.

FIG. 1b—shows a front view of the device according to the present invention.

FIG. 2a—shows a view of the inside of the right outer cover according to the present invention.

FIG. 2b—shows a view of the inside of the left outer cover according to the present invention.

FIG. 3—shows a view of the applicator placed on the fishing rod ready to proceed according to the indicated in the present invention.

### DETAILED DESCRIPTION OF THE SEVERAL EMBODIMENTS

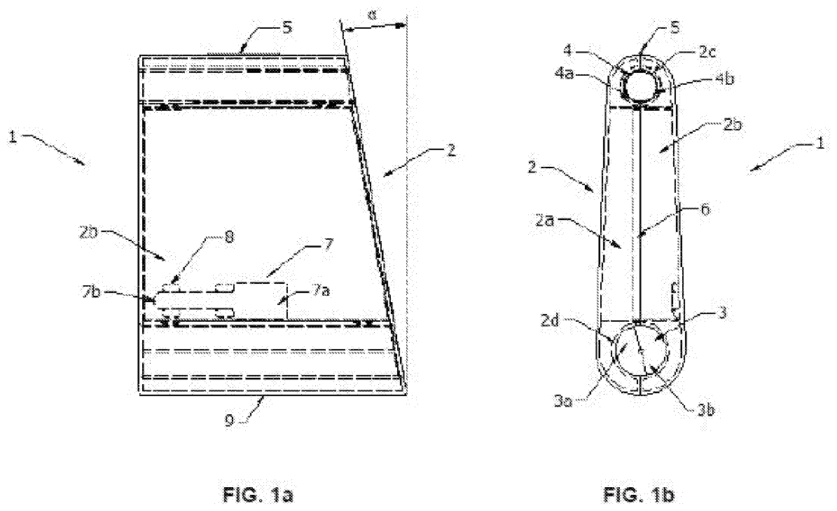

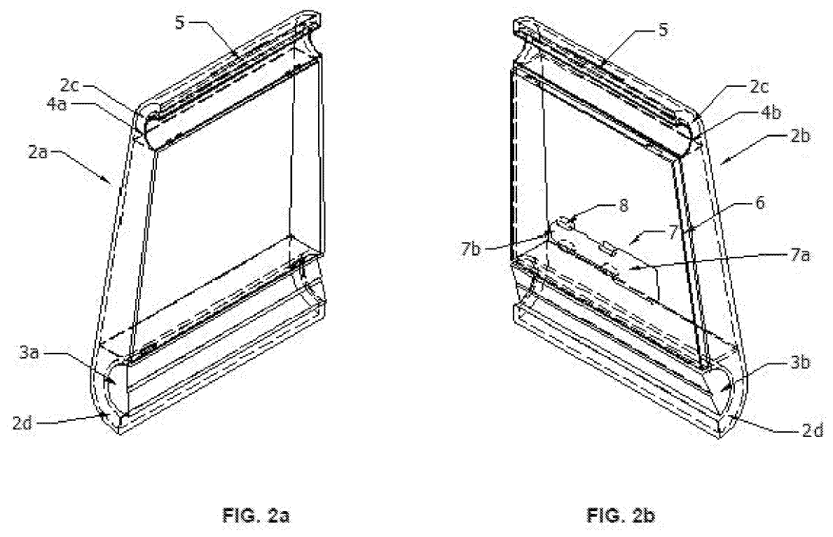

Referring to the accompanying figures, now it is described a particular example of a lubricant applicator (1) for lines and the different sections which make up the fishing leader according to the present invention. Particularly, FIGS. 1a and 1b show each a side and elevation views of the lubricant applicator (1) where the outer cover (2), the support material of the lubricant (3), the protecting material (4) and the axis of rotation as a hinge (5) can be observed.

The outer cover (2) is made of two parts, the right outer cover (2a) and the left outer cover (2b). The right outer cover (2a) has the essentially semicircular halves of the upper (2c) and lower (2d) holes. In the case of the semicircular half of the upper hole (2c) this is covered with protecting material (4a) not to damage the rod, while the semicircular half of the lower hole (2d) has the half of the grooved support material (3a) to be able to place the lubricant and adhered to the semicircular half of the lower hole (2d) of the right outer cover (2a). Its internal part presents a pocket which allows to house utensils or other materials.

The left outer cover (2b) has the other essentially semicircular halves of the upper (2c) and lower (2d) holes. Like in the outer cover (2a) the semicircular half of the upper hole (2c) is covered with protecting material (4b) not to damage the rod and the semicircular half of the lower hole (2d) has the other half of the support material (3b), also grooved to be able to place the lubricant and adhered to the semicircular half of the lower hole (2d) of the left outer cover (2b). Its internal part also presents a pocket whose object is housing materials or other elements, as well as the tool for impregnation of the support material (7) with the lubricant, fitted into the relevant fixing flanges (8). This tool for impregnation of the support material (7) has two differentiated sections as indicated, the first of them corresponds to the holding section (7a) of approximate dimensions of 15 mm long by 10 mm wide, and a second, the section to spread the lubricant (7b), certainly slim whose approximate dimensions are of 20 mm long by 5 mm wide, whose object is to distribute the desired quantity of lubricant on the support material.

The a angle formed by the vertical with the front faces of the outer cover (2) is of approximately 10° in this example, although other angles could be used as indicated above. This can be noticed in FIG. 1a and its purpose is helping the user to have an adequate visual control of the operation when they proceed with the system placed in the rod. The rear part of the lubricant applicator (1) is essentially perpendicular to the axis of rotation or hinge (5).

The width of the lubricant applicator (1) increases in an approximately linear manner from the upper hole, with a value similar to 18 mm up to the lower hole, where its width is of approximately 25 mm. This can be noticed in FIG. 1b where the lubricant applicator (1) is shown in its elevation view.

The assembly between the right outer cover (2a) and the left outer cover (2b) is achieved by the existing perimeter flange (6) preferably in the left outer cover (2b), which engages through the inside of the pocket of the right outer cover (2a). To secure the closure of both parts, in the existing perimeter flange (6) in the left outer cover (2b), there are preferably several protuberances which fit into the corresponding hollows present on the internal faces of the pocket of the right outer cover (2a). The union between the right outer cover (2a) and the left outer cover (2b) is achieved through the axis of rotation (5) on which both pieces move, which functions as a hinge, which may be connected both to the right outer cover (2a) and the left outer cover (2b) and through parts assembled thereto. Although this is the system explained for this example, the separation between both covers could be achieved in such a way that contact would be completely lost between both as indicated above.

This innovative lubricant applicator (1) allows a comfortable, easy, clean lubrication and winding and with guarantees. It provides the possibility to put in contact this set with the support material of the lubricant (3) impregnated with the product intended for this purpose. This is achieved by the opening the right (2a) and left (2b) outer covers through their axis of rotation as a hinge (5), placing afterwards the desired quantity of lubricant on the support material (3), to put right after this, and in its inside, an essentially straight fragment of the fishing line and/or leaders to be greased. The outer cover (2) closed, the user carries out the winding operation in such a way that the elements to be lubricated (11) are greased when passing through the support material of the lubricant (3) to be stored into the reel. This operation is carried out being the lubricant applicator (1) attached to the rod through the upper hole (4), covered with the protecting material (4a and 4b).

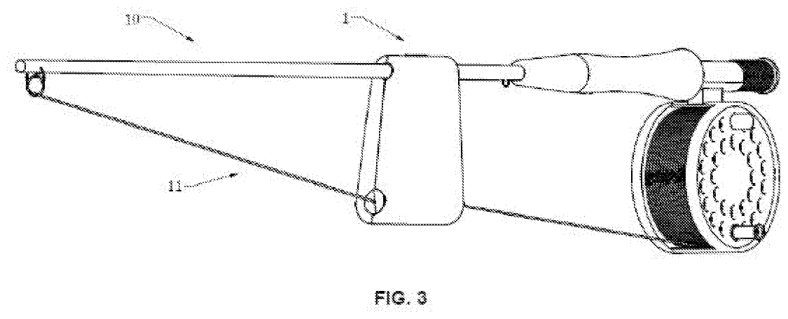

In FIG. 3, the lubricant applicator (1) can be observed placed in the closest section to that of the rod's handle (10) where a section of the elements to be lubricated (11) is housed in the support material (3).

What is claimed is:

1. A lubricant applicator (1) for fishing lines and leaders of the modality known as “with tapered leaders”, “whip fishing” or “fly fishing” comprising an outer cover (2), the support material of the lubricant (3) placed in the lower hole (2d) and divided into two parts (3a and 3b), the protecting material (4) placed in the upper hole (2c), characterized by comprising the outer cover, a right outer cover (2a) and a left outer cover (2b), each of these outer covers comprising in turn, the essentially semicircular halves of the upper (2c) and lower (2d) holes.

2. The lubricant applicator (1) according to claim 1, wherein the right outer cover (2a) and the left outer cover (2b) are joined by the axis of rotation as a hinge (5) enabling the opening of the assembly.

3. The lubricant applicator (1) according to claim 1, wherein the right outer cover (2a) and the left outer cover (2b) are completely separated enabling the opening of the assembly.

4. The lubricant applicator (1) according to claim 1, wherein the right outer cover (2a) and the left outer cover (2b) are assembled.

5. The lubricant applicator (1) according to claim 4, wherein the right outer cover (2a) and the left outer cover (2b) are assembled by means of the existing perimeter flange (6), either in the left outer cover (2b), or, in the right outer cover (2a), which engages through the inside of the pocket of the other outer cover.

6. The lubricant applicator (1) according to claim 1, wherein the outer cover (2) contains the fixing flanges (8) of the tool for impregnation of the support material (7), placed in the right outer cover (2a) or in the left outer cover (2b).

7. The lubricant applicator (1) according to claim 1, which contains a tool for impregnation of the support material (7).

8. The lubricant applicator (1) according to claim 1, wherein the upper (2c) and lower (2d) holes are essentially circular.

9. The lubricant applicator (1) according to claim 1, wherein the axis of the upper (2c) and lower (2d) holes are coplanar.

10. The lubricant applicator (1) according to claim 1, wherein the axis of the upper (2c) and lower (2d) holes are not coplanar.

11. The lubricant applicator (1) according to claim 1, wherein the support material of the lubricant (3) placed on the lower hole (2d) has smooth faces.

12. The lubricant applicator (1) according to claim 1, wherein the support material of the lubricant (3) placed on the lower hole (2d) is grooved.

13. The lubricant applicator (1) according to claim 1, wherein the angle formed by the vertical with the front faces (a) of the outer cover (2) is between 0° and 20°.

14. The lubricant applicator (1) according to claim 13, wherein the angle formed by the vertical with the front faces (a) of the outer cover (2) is between 10° and 15°.

15. The lubricant applicator (1) according to claim 1, wherein the angle formed by the vertical with the lower edge (9) is between 30° and 150°.

16. The lubricant applicator (1) according to claim 1, wherein the separation between the upper hole (2c) and the lower hole (2d) is from 2 centimeters to 15 centimeters.
